(19) United States
(12) Patent Application Publication
(10) Pub. No.: US 2013/0265293 A1
(43) Pub. Date: Oct. 10, 2013

(54) PROJECTION TYPE DISPLAY DEVICE AND METHOD OF RESTART PROCESSING

(71) Applicants: Kenji Kanzaka, Tokyo (JP); Michio Kobayashi, Tokyo (JP); Hiroki Tanaka, Tokyo (JP); Yukinori Shioya, Tokyo (JP)

(72) Inventors: Kenji Kanzaka, Tokyo (JP); Michio Kobayashi, Tokyo (JP); Hiroki Tanaka, Tokyo (JP); Yukinori Shioya, Tokyo (JP)

(21) Appl. No.: 13/993,966

(22) PCT Filed: Dec. 16, 2010
(86) PCT No.: PCT/JP2010/072669

§ 371 Date: Jun. 13, 2013

(51) Int. Cl. G03B 21/14

(52) U.S. Cl. CPC G03B 21/14
USPC 345/212

(57) ABSTRACT

An object of the present invention is to reduce the power consumption of a lamp that maintains lighting state after a power OFF operation is performed. The display device includes a lamp driver that supplies drive power to a lamp employing a halogen cycle; and a controller that controls the lamp driver to supply power that is lower than rated power of the lamp and that is lower than power satisfying the halogen cycle to the lamp for a predetermined lamp and then cause the lamp to extinguish, when the controller receives a light off signal that causes the lamp to extinguish.

### TECHNICAL FIELD

The present invention relates to a projection type display device and a method of restart processing.

### BACKGROUND ART

Generally, high-pressure discharge lamps such as ultra-high pressure mercury vapor lamps and xenon lamps have been used as light sources of projection type display devices. An ultra-high pressure mercury vapor lamp is a lamp that is composed of a sealed gas bulb (glass tube) filled with mercury, argon gas, and the like together with a trace amount of halogen.

In a super-high pressure mercury vapor lamp, when tungsten (W) that is used as an electrode becomes incandescent and evaporates, vapor of tungsten migrates to the neighborhood of the inner wall of the bulb and combines with halogen (X) contained in the bulb. As a result, tungsten halide (WX₂) is formed. The tungsten halide circulates inside the bulb. When the tungsten halide is heated in the neighborhood of the electrode at a predetermined temperature (around 1400° C. or higher), the tungsten halide dissociates into halogen and tungsten. The dissociated tungsten returns to the electrode. The tungsten evaporates again and then combines with halogen. This sequence of the repeated chemical reaction is referred to as halogen cycle.

To reduce the power consumption of the lamp, it is preferred to use a projection type display device provided with a dimming function that increases and decreases the quantity of light emitted from the lamp. In the projection type display device provided with the dimming function, if the quantity of light emitted from the lamp lowers, the power consumption of the lamp decreases. If the power consumption of the lamp decreases, the rise of the temperature in the enclosure of the device is suppressed. Thus, the power consumption of a cooling means such as a fan also decreases.

Generally, the quantity of light of the lamp is adjusted by the dimming function in the range of 80% to 100% of the rated power of the lamp so as to satisfy the halogen cycle (hereinafter this range is referred to as dimming range). Power supplied to the lamp can be decreased compared with the dimming range so as to further decrease the quantity of light of the lamp. However, if the lamp is caused to light with power lower than the dimming range (hereinafter this state is referred to as lighting with low power), it becomes difficult to maintain the temperature in the bulb of the lamp at a temperature that satisfies the halogen cycle. As a result, blackening occurs inside the bulb and thereby the quantity of light emitted from the lamp decreases. The blackening that occurs inside the lamp represents a state in which a vapor of tungsten becomes black powder and adheres to the inner wall surface of the bulb.

As a technique that suppresses the blackening that occurs inside the lamp that lights with low power, a refresh function is known. In the refresh function, power that needs to satisfy the halogen cycle is supplied to the lamp for a predetermined time at a predetermined interval that depends on power supplied to the lamp. The refresh function prevents the life of the lamp from becoming shortening even when the lamp is caused to light with low power.

On the other hand, since the temperature and inner pressure of the lamp that just extinguished are higher than those of the lamp that has not lighted, it becomes difficult to electrically discharge in the lamp that just extinguished. Thus, if the lamp is caused to extinguish and light immediately thereafter, it may fail to discharge and thereby it may not light up.

Thus, if the lamp is caused to extinguish and light immediately thereafter, the lamp needs to be cooled by a cooling fan or the like in a cooling period ranging from several ten seconds to several minutes. Patent Literature 1 describes a projection type display device that can immediately projects an image even if the power OFF operation is immediately followed by the power ON operation. Specifically, when the device receives a signal that causes the power supply to be turned off, the device keeps the lamp lighting after the device receives the signal for turning off the power until a predetermined time period elapses. At this point, the device causes the lamp to light with lower power than when the device receives the signal for turning off the power so as to reduce the power consumption of the lamp.

### CITATION LIST

### Patent Literature(s)

Patent Literature 1: JP2005-156751A

### SUMMARY OF THE INVENTION

### Problem to be Solved by the Invention

In the projection type display device described in Patent Literature 1, the device causes the lamp to light with power that satisfies the halogen cycle after the device receives the signal that causes the power supply to be turned off until a predetermined time elapses. To further decrease the power consumption of the projection type display device, the lamp drive power needs to be decreased in this period. However, if the lamp is caused to light with low power, a problem that blackening occurs inside the lamp arises. Although it can be expected to some extent that blackening that occurs inside the lamp is prevented by the refresh function, after the power supply is turned off, the refresh function is not executed. In other words, for the lamp in a lighting state after the signal that causes the power supply to be turned off is received, it is difficult to further decrease the power consumption of the lamp.

An object of the present invention is to provide a projection type display device and a restart processing method that can reduce the power consumption of a lamp that maintains lighting state after the power OFF operation.

### Means for Solving Problem

A projection type display device according to the present invention is a projection type display device including a lamp employing a halogen cycle; and a display element modulating light emitted from the lamp in response to an image signal, and includes: a controller generating a control signal that causes first power to be supplied to the lamp and then causes supplying of power to the lamp to be stopped after elapse of a predetermined first time when the controller receives a light OFF signal that causes the lamp to extinguish, the first power being lower than a rated power of the lamp and being lower than power that satisfies the halogen cycle; and a supply unit supplying power to the lamp in accordance with the control signal.

A method of restart processing according to the present invention is a method of restart processing for a projection type display device including a lamp employing a halogen cycle; and a display element modulating light emitted from the lamp in response to an image signal, and includes: when receiving a light OFF signal that causes the lamp to extinguish, generating a control signal that causes first power to be supplied to the lamp and then causes supplying of power to the lamp to be stopped after elapse of a predetermined first time, the first power being lower than a rated power of the lamp and being lower than power that satisfies the halogen cycle; and supplying power to the lamp in accordance with the control signal.

### Advantageous Effects of the Invention

According to the present invention, it is possible to reduce the power consumption of the lamp that maintains the lighting state light after the power supply is turned off.

### BRIEF DESCRIPTION OF DRAWINGS

FIG. 1 is a diagram showing a projection type display device according to an embodiment of the present invention;

FIG. 2 is a diagram describing a state transition of projection type display device 1: and

FIG. 3 is a flowchart showing an example of a procedure of a restart processing method.

### DESCRIPTION OF EMBODIMENTS

Embodiments of the present invention will be described with reference to the accompanying drawings.

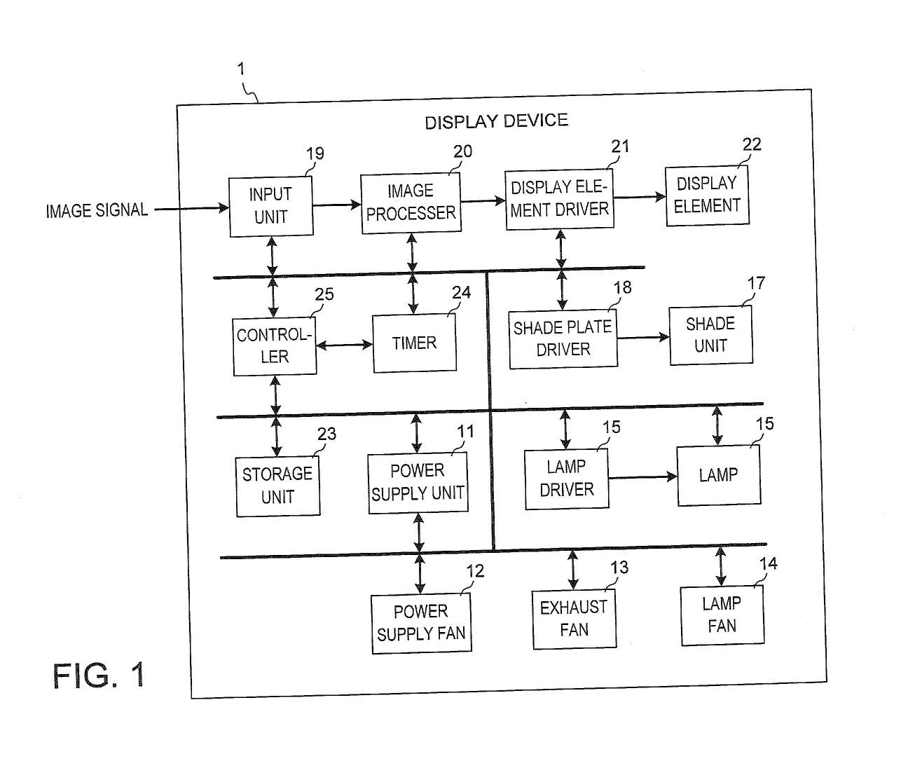

FIG. 1 is a diagram showing display device 1 according to a first embodiment of the present invention.

Display device 1 is a projection type display device provided with a refresh function for lamp 16.

Display device 1 is provided with power supply unit 11, power supply fan 12, exhaust fan 13, lamp fan 14, lamp driver 15, lamp 16, shade unit 17, shade plate driver 18, input unit 19, image processer 20, display element driver 21, display element 22, storage unit 23, timer 24, and controller 25.

Power supply unit 11 receives a power voltage from a commercial power supply. For example, power supply unit 11 is connected to the commercial power supply using a power supply switch or the like and receives a 100 V power voltage therefrom.

When power supply unit 11 receives the power voltage from the commercial power supply, power supply unit 11 supplies the power voltage to controller 25. According to the present embodiment, the state in which power supply unit 11 supplies the power voltage only to controller 25 is referred to as standby mode (third operation state). The standby mode represents the state that lamp 16 is caused to extinguish and no image is projected. This standby mode is the same as the standby mode (standby state) of an ordinary projection type display device.

When the power ON operation is performed, power supply unit 11 supplies the power voltage to each of power supply fan 12, exhaust fan 13, lamp fan 14, lamp driver 15, lamp 16, shade plate driver 18, input unit 19, image processor 20, display element driver 21, display element 22, storage unit 23, timer 24, and controller 25. When display device 1 receives a light ON signal, display device 1 causes lamp 16 to light and projects an image. According to the present embodiment, the state in which display device 1 projects an image is referred to as normal operation state (first operation state).

Power supply fan 12 is used to cool power supply unit 11.

Exhaust fan 13 is used to exhaust air from the inside of the enclosure of display device 1.

According to the present embodiment, lamp 16 is an ultra-high pressure mercury vapor lamp employing the halogen cycle. Lamp 16 generally satisfies the halogen cycle in the state that power of around 80% to 100% of the rated power thereof is supplied thereto. In other words, if power lower than around 80% of the rated power is continuously supplied to lamp 16, since lamp 16 cannot maintain the halogen cycle, blackening inside the lamp will occurs.

Thus, when display device 1 supplies power lower than the power that satisfies the halogen cycle to lamp 16 (hereinafter this power is referred to as “low power”), display device 1 needs to execute the refresh function. In this case, power with which display device 1 needs to execute the refresh function is power lower than the power that needs to satisfy the halogen cycle for lamp 16. The low power may be referred to as first power.

Lamp driver 15 may be generally referred to as supply unit.

Lamp driver 15 supplies power to lamp 16 in accordance with a control signal received from controller 24. When lamp driver 15 receives the light ON signal, lamp driver 15 supplies, for example, drive power that needs to satisfy the halogen cycle for lamp 16 thereto.

Lamp fan 14 may be generally referred to as cooling means and is used to cool lamp 16.

Shade unit 17 is used to block part or all of light emitted from lamp 16. Shade unit 17 is accomplished by, for example, a shade plate located between lamp 16 and display element 22 or a shade plate located in a projection lens.

Shade unit 17 and shade plate driver 18 altogether may be referred to as shade means.

Shade plate driver 18 adjusts the quantity of light emitted from lamp 16 to a predetermined quantity of light. Shade plate driver 18 drives shade unit 17 so as to increase or decrease the opening area through which a beam of light emitted from lamp 16 passes. Thus, shade plate driver 18 can change the quantity of light with which display element 22 is irradiated.

Input unit 19 receives an image signal that represents an image from an image supply device such as a personal computer.

When image processer 20 receives an image signal from input unit 19, image processer 20 executes a predetermined process for the image signal. When input unit 19 receives, for example, an image signal which is an analog signal, image processer 20 converts the image signal into a digital signal and generates image data. Image processer 20 supplies the image data to display element driver 21 frame by frame.

When display element driver 21 receives the image data from image processer 20, display element driver 21 generates a drive signal that drives display element 22 so as to project an image represented by the image data. Display element driver 21 supplies the drive signal to display element 22.

Display element 22 modulates light emitted from lamp 16 in response to the image signal and projects the modulated light as an image to a screen.

According to the present embodiment, when display element 22 receives the drive signal from display element driver 21, display element 22 modulates light emitted from lamp 16 in response to the drive signal. Display element 22 modulating light is, for example, a liquid crystal panel, a DMD, or the like.

Storage unit 23 stores light OFF process information that represents a light OFF process that is performed when a light OFF signal causing the lamp to extinguish is supplied by a user's operation. The light OFF process information represents a value of the low power that is lower than both the rated power of lamp 16 and the power that satisfies the halogen cycle for lamp 16, and a maximum retention time (first time) for which lamp 16 lights with the low power.

A value of, for example, 30% or less of the rated power of lamp 16 is used as the low power value. According to the present embodiment, a value of 25% of the rated power of lamp 16 is used as the low power value.

The maximum retention time has been preset to a time for which bulb blackening due to the low power lighting of lamp 16 can be avoided. In other words, the maximum retention time is a time for which blackening does not occur inside lamp 16 even when lamp 16 is driven with low power.

Timer 24 measures a time for which lamp 16 lights with low power (hereinafter, this time is referred to as “retention time”). When timer 24 receives a measurement signal that causes the retention time to be measured from controller 25, timer 24 starts measuring the retention time and outputs the measured retention time to controller 25.

When controller 25 receives the light OFF signal that cause lamp 16 to extinguish, by a user's operation, controller 25 controls lamp driver 15 to supply low power to lamp 16 for the maximum retention time, and then causes lamp 16 to extinguish. Specifically, when controller 25 receives the light OFF signal, controller 25 generates a control signal that causes low power to be supplied to lamp 16 and then supplies the control signal to lamp driver 15. Thereafter, controller 25 also generates a control signal that causes power supplied to lamp 16 to be stopped after an elapse of the maximum retention time and then supplies the control signal to lamp driver 15.

When controller 25 receives the light ON signal that causes lamp 16 to light, controller 25 supplies the light ON signal to lamp driver 15. Thereafter, lamp driver 15 supplies drive power that needs to satisfy the halogen cycle to lamp 16.

According to the present embodiment, controller 25 receives an operation signal which is input by a user's operation. When controller 25 receives the light OFF signal as an operation signal, controller 25 supplies the light OFF process information stored in storage unit 23 to lamp driver 15 as a control signal. When lamp driver 15 receives the light OFF process information, lamp driver 15 supplies power (low power) having a value represented by the light OFF process information to lamp 16. In other words, lamp 16 performs low power lighting in which lamp 16 lights with lower power that is 30% or less of the rated power of lamp 16. According to the present embodiment, lamp 16 performs low power lighting in which it lights with low power that is 25% of the rated power of lamp 16.

When controller 25 receives the light OFF signal, controller 25 supplies the measurement signal to timer 24. Thereafter, when the retention time that timer 24 outputs becomes the maximum retention time represented by the light OFF process information, controller 25 supplies a stop signal that causes power supplied to lamp 16 to be stopped to lamp driver 15 as a control signal. When lamp driver 15 receives the stop signal, lamp driver 15 stops supplying low power to lamp 16. As a result, lamp 16 extinguishes.

After controller 25 has supplied the measurement signal to timer 24, if controller 25 receives the light ON signal as an operation signal before the retention time becomes the maximum retention time, controller 25 supplies the light ON signal to lamp driver 15. When lamp driver 15 receives the light ON signal, lamp driver 15 supplies drive power that is, for example, start power that needs to satisfy the halogen cycle to lamp 16. Start information representing a start power value and a specified period has been stored, for example, in storage unit 23.

In other words, when display device 1 receives the light ON signal which is input by a user's operation within the maximum retention time, since lamp 16 still maintains lighting state, display device 1 can immediately project an image.

According to the present embodiment, the state in which controller 25 receives the light OFF signal and lamp 16 lights with low power is referred to as idling mode. In other words, when controller 25 receives the light OFF signal, controller 25 causes display device 1 to enter the idling mode. An example of a process executed during the idling mode will be described.

When controller 25 receives the light OFF signal, display element 22 projects, for example, a black image. In this example, when controller 25 receives the light OFF signal, controller 25 supplies a test pattern signal that causes a test pattern to be generated to image processer 20. When image processer 20 receives the test pattern signal, image processer 20 generates a test pattern of a black image. Display element driver 21 writes the test pattern of the black image to display element 22. Thus, display element 22 projects the black image to the screen.

Therefore, display device 1 projects the black image in the idling mode such that the projection image becomes dark as if lamp 16 extinguishes. Thus, display device 1 can operate in the idling mode similar to the standby mode.

Alternatively, when controller 25 receives the light OFF signal, controller 25 supplies the light OFF signal to shade plate driver 18. Shade plate driver 18 then drives shade unit 17 to decrease or block light emitted from lamp 16 that lights with low power. Through this operation, display device 1 can darken projection screen by driving shade unit 17 to decrease or block light emitted from lamp 16 in the standby mode. As a result, even in a dark room, the user can be prevented from being bothered by light emitted from lamp 16. At this point, since lamp 16 lights with low power, the rise of temperature of shade unit 17 is suppressed.

When controller 25 receives the light OFF signal, controller 25 stops supplying the power voltage to circuits that are not concerned with lighting of lamp 16. The circuits that are not concerned with the lighting of lamp 16 include, for example, part or all of each of input unit 19, image processer 20, display element driver 21, and display element 22. Image processer 20, display element driver 21, and display element 22 can be quickly activated within several seconds to several ten seconds compared with a time that needs to cause lamp 16 to light again (for example, it takes several ten seconds to several minutes in case of forced cooling by lamp fan 14).

Thus, in the idling mode, the power consumption of display device 1 is decreased and also heat generated in display device 1 is suppressed. If the power voltage supplied to display element 22 is stopped in the idling mode, it is preferred that display element 22 be a normally black type liquid crystal panel (display device). A normally black type liquid crystal panel does not output incident light unless a power voltage is supplied. In other words, a normally black type liquid crystal panel displays a black screen unless a power voltage is supplied.

When controller 25 receives the light OFF signal, controller 25 controls the rotation rate of each of power supply fan 12, exhaust fan 13 and lamp fan 14. For example, when controller 25 receives the light OFF signal, controller 25 decreases the rotation rate of lamp fan 14 to a rate that is lower than the rotation rate of lamp fan 14 that occurred immediately before controller 25 receives the light OFF signal. Alternatively, controller 25 may stop lamp fan 14. Further alternatively, controller 25 may detect the temperature in the neighborhood of lamp 16 and change the rotation rate of lamp fan 14 according to the detected temperature. Further alternatively, since the number of circuits that operate in display device 1 is small, controller 25 may decrease the rotation rates of power supply fan 12 and exhaust fan 13.

Thus, display device 1 can reduce noise and power consumption that occur in fans 12 to 14 by decreasing the rotation rates of fans 12 to 14 in the idling mode compared with those in the normal operation state.

Display device 1 may execute a combination of the foregoing examples of the processes in the idling mode. When display device 1 executes a combination of the foregoing examples of the processes, display device 1 can operate in the idling mode more similar to the standby mode.

Controller 25 may cause lamp 16 to light with low power in the normal operation state. For example, when the image signal is not supplied to input unit 19, controller 25 sets the level of power delivered from lamp driver 15 for low power. Alternatively, controller 25 may detect the brightness in the neighborhood of display device 1. If the detected brightness is lower than a predetermined threshold, controller 25 sets the level of power delivered from lamp driver 15 for low power. When the lamp is driven with low power, controller 25 performs a lamp refresh process in accordance with a predetermined condition.

Here, the lamp refresh process will be described in brief.

The lamp refresh process is a process that temporarily increases drive power of the lamp in order to prevent blackening inside the lamp when the lamp is driven with low power. The allowable interval and period for the lamp refresh process have been set for display device 1.

The allowable interval is a time at which low power is supplied to lamp 16. The allowable interval may be also referred to as specified period. The allowable interval is set on the basis of the maximum allowable time. The maximum allowable time is a time for which blackening is prevented from occurring inside lamp 16 even if lamp lights with low power.

The refresh period is a period for which refresh power that needs to satisfy the halogen cycle for lamp 16 is supplied thereto. Refresh power has been preset to a value close to a power value of the rated power of lamp 16. For example, refresh power is set to one of power values ranging from around 80% to 100% of the rated power of lamp 16.

The maximum allowable time and refresh period have been specified for each type of the lamp so as to prevent blackening of the bulb. In the low power lighting of lamp 16 in the present embodiment, the maximum allowable time and refresh period are specified as 30 minutes and 2 minutes or longer, respectively. As a result, the allowable interval and refresh period have been set to 20 minutes and 2 minutes, respectively. The lamp refresh information that represents the allowable interval, refresh period and refresh power has been stored, for example, in storage unit 23.

In the lamp refresh process, timer 24 measures the low power light ON time for which lamp 16 lights with low power and the high power light ON time for which lamp 16 light with refresh power.

When lamp 16 starts lighting with low power, controller 25 uses timer 24 and starts measuring the low power light ON time. When the low power light ON time reaches the allowable interval, controller 25 causes lamp driver 15 to supply refresh power to lamp 16.

When lamp driver 15 supplies refresh power to lamp 16, controller 25 resets timer 24 and uses it to start measuring the high voltage light ON time. At this point, the quantity of light that is emitted from lamp 16 is greater than the quantity of light emitted from lamp 16 that lights with low power, the luminance of the display screen becomes high.

Thus, controller 25 controls shade plate driver 18 to adjust the quantity of light emitted from lamp 16 to a predetermined quantity of light emitted from lamp 16 that lights with low power such that changes of the luminance of the display screen do not become visually obstructive. Therefore, shade plate driver 18 drives shade unit 17 to shade part of light emitted from lamp 16 that lights with refresh power.

When the high voltage light ON time reaches the refresh period, controller 25 causes lamp driver 15 to supply drive power of low power to lamp 16 again and thereby causes lamp 16 to start lighting with low power. When lamp 16 starts lighting with low power, controller 25 resets timer 24 and use it to start measuring the low power light ON time. Thereafter, the foregoing operation is repeated until lamp 16 does not light with low power. In other words, when low power is supplied to lamp 16, lamp driver 15 supplies refresh power to lamp 16 at the allowable interval for the refresh period.

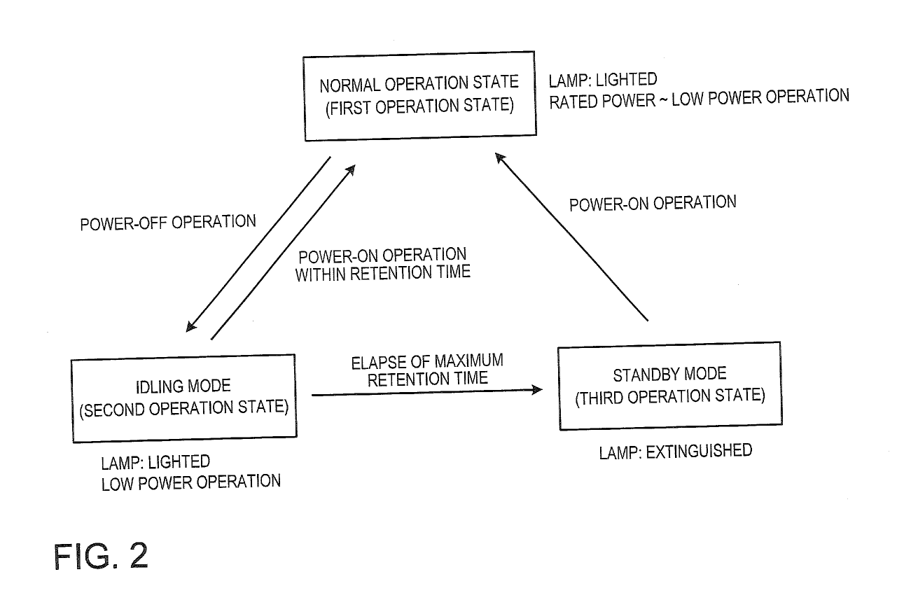

FIG. 2 is a diagram describing a state transition of display device 1.

FIG. 2 shows a normal operation state, an idling mode and a standby mode.

The normal operation state (first operation state) is a state in which display device 1 causes lamp 16 to light and thereby projects an image. The idling mode (second operation state) is a state in which lamp 16 lights with low power. The standby mode (third operation state) is a state in which display device 1 causes lamp 16 to extinguish and thereby does not project an image.

When display device 1 is connected to the commercial power, display device 1 is supplied with a 100 V power voltage therefrom and enters the standby mode.

In the standby mode, when the light ON signal is input by an operation causing the power supply to be turned on, display device 1 enters the normal operation state. In the normal operation state, display device 1 starts all electronic circuits that serve to project an image and so as to cause lamp 16 to light and project an image. Display device 1 may cause lamp 16 to light with low power in the normal operation state.

In the normal operation state, when the light OFF signal is input by an operation causing the power supply to be turned off, display device 1 enters the idling mode. The operation causing the power supply to be turned off is, for example, an operation of pressing a power button located on display device 1 or a power button located on a remote controller one time.

In the idling mode, the projected screen is darkened by decreasing the quantity of light of lamp 16 or displaying a black screen such that display device 1 operates similarly to the state in which lamp 16 extinguishes.

When display device 1 enters the idling state, controller 25 resets timer 24 and measures, by timer 24, the retention time for which lamp 16 lights with low power.

In case that, in the idling mode, the retention time measured by timer 24 is shorter than the maximum retention time that has been preset, when the light ON signal is input by an operation causing the power supply to be turned on, display device 1 shifts from the idling mode to the normal operation state. Since lamp 16 has not extinguished, but kept lighting, when display device 1 receives the light ON signal, display device 1 can immediately enter the normal operation state.

On the other hand, in the idling mode, when the retention time measured by timer 24 exceeds the maximum retention time, display device 1 shifts from the idling mode to the standby mode. In the standby mode, display device 1 causes lamp 16 to extinguish and stops supplying the power voltage to unnecessary electronic circuits.

In FIG. 2, it is assumed that the maximum retention time in the idling mode is 10 minutes. Even if lamp 16 that has carried out low power lighting for 20 minutes in the normal operation state enters the idling mode, the cumulative light ON time for which lamp 16 has lighted with low power (=20 minutes+10 minutes) can be within 30 minutes that is the maximum allowable time for low power lighting of lamp 16.

When causing lamp 16 to light again, lamp driver 15 supplies start power having the same level as refresh power to lamp 16 for the specified time or longer. As a result, it is possible to obtain the same advantageous effect as that is obtained by the lamp refresh process.

Next, the operation of display device 1 will be described.

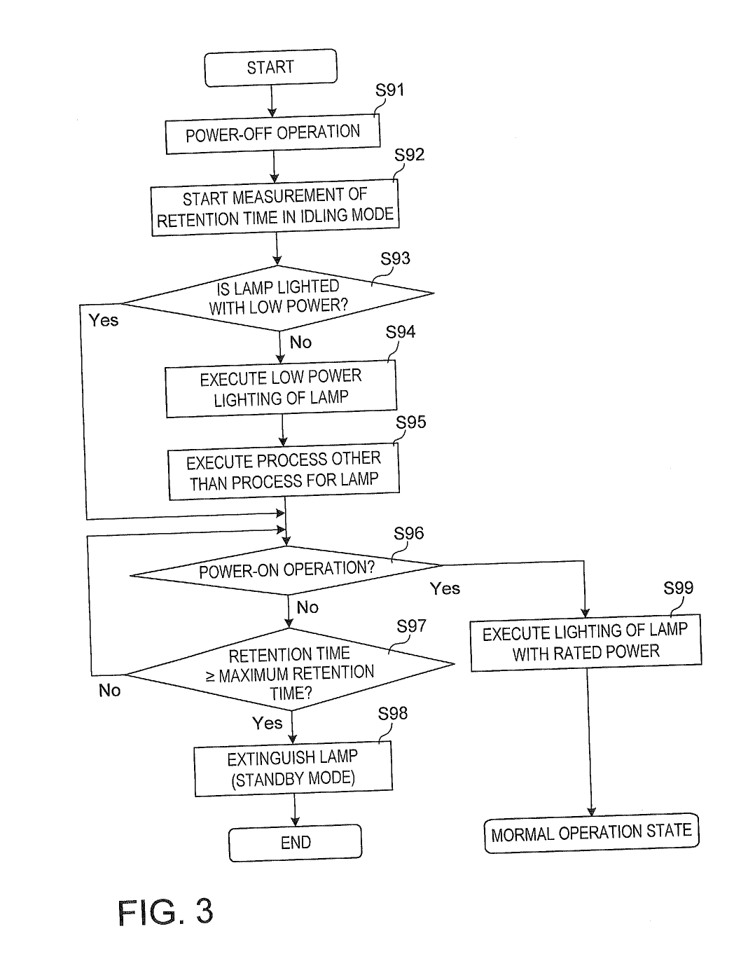

FIG. 3 is a flow chart showing an example of a procedure of a restart processing method.

While lamp 16 lights with the rated power, an operation for turning off the power supply is performed, and controller 25 receives the light OFF signal that causes lamp 16 to extinguish (at step S91).

Thereafter, controller 25 resets timer 24 and uses it to start measuring the retention time in the idling mode (at step S92).

Controller 25 then determines whether or not lamp 16 lights with low power (at step S93). Specifically, controller 25 receives power information representing the value of drive power from lamp driver 15 and determines whether or not the value of drive power is a value of low power. If lamp 16 does not light with low power, controller 25 controls lamp driver 15 to supply low power to lamp 16 (at step S94). In other words, controller 25 executes the light OFF process for lamp 16.

When lamp driver 15 supplies low power to lamp 16, controller 25 executes a process other than the light OFF process for lamp 16 (at step 95). A process other than the light OFF process of lamp 16 is, for example, a process that projects a black image to the screen, a process that causes shade unit 17 to decrease or block light emitted from lamp driver 15, or a process that decreases the rotation rate of lamp fan 14.

Thereafter, controller 25 checks whether or not the light ON signal has been input by an operation for turning on the power supply (at step S96). If lamp 16 lights with low power, controller 25 checks whether or not the light ON signal has been input (at step 96)

If the light ON signal has not been input, controller 25 determines whether or not the retention time measured by timer 24 exceeds the maximum retention time (at step S97). If the retention time exceeds the maximum retention time, controller 25 causes lamp 16 to extinguish, enters the standby mode (at step S98), and then completes a sequence of the procedure of the restart processing method.

In contrast, if controller 25 has received the light ON signal before the retention time reaches the maximum retention time, lamp driver 15 supplies drive power of the rated power to lamp 16 and causes lamp 16 to light with the rated power (at step S99). Then, display device 1 enters the normal operation state.

In the projection type display device having the refresh function for lamp 16 according to the first embodiment, when controller 25 receives the light OFF signal that causes lamp 16 to extinguish, controller 25 controls lamp driver 15 to supply low power (first power) to lamp 16 for the maximum retention time (first time) and then causes lamp 16 to extinguish.

Thus, the projection type display device according to the present invention can decrease power supplied to lamp 16 that has kept lighting after the power OFF operation is performed and thereby decreases the power consumption of lamp 16 without necessity of being concerned about blackening inside the lamp. In addition, the projection type display device according to the present invention can cause the lamp to light again immediately after it extinguishes.

Next, a projection type display device according to a second embodiment of the present invention will be described.

While display device 1 is operating in the normal operation state, lamp 16 may light with low power. In this case, it is likely that if display device 1 enters the idling mode, the low power light ON time may exceed the maximum retention time. To solve this problem, the maximum retention time for which display device 1 operates in the idling mode is calculated on the basis of the allowable time for which the lamp lights with low power and the time for which the lamp lights with low power in the normal operation state and then judgment of entering the normal operation state or the standby mode is made on the basis of the calculated maximum retention time.

In the normal operation state, timer 24 measures the low power light ON time for which lamp 16 lights with low power and the high voltage light ON time for which lamp 16 lights with refresh power. Controller 25 executes the lamp refresh process according to the time measured by timer 24. Thus, when lamp driver 15 receives the light ON signal and supplies low power to lamp 16, lamp driver 15 supplies refresh power to lamp 16 at the allowable interval.

Controller 25 obtains, as shown in Eq. 1, the maximum retention time Tₘₐₓ by subtracting the low power light ON time T₁ of lamp 16 in the normal operation state from the maximum allowable time Tₗᵢₘ of the low power lighting of lamp 16, and makes judgment of entering the normal operation state or the standby mode on the basis of the maximum retention time Tₘₐₓ. According to the present embodiment, the maximum retention time Tₗᵢₘ of low power lighting of lamp 16 is stored, for example, in storage unit 23.

Tₘₐₓ=Tₗᵢₘ−T₁ Eq. 1

In a state that lamp 16 lights with low power, if display device 1 enters the idling mode and the retention time in the idling mode becomes equal to or greater than the maximum retention time Tₘₐₓ calculated according to Eq. 1, controller 25 causes display device 1 to enter the standby mode. In other words, if controller 25 receives the light OFF signal in a state that lamp driver 15 is supplying low power to lamp 16, controller 25 generates a control signal that causes lamp to extinguish when the maximum retention time Tₗᵢₘ elapses from the supplying of low power to lamp 16. When lamp driver 15 receives the control signal, lamp driver 15 stops supplying power to lamp 16 and thereby it extinguishes.

In a state that lamp 16 lights with low power, if controller 25 enters the idling mode and receives the light ON signal within the maximum retention time, controller 25 causes display device 1 to enter the normal operation state.

Next, a projection type display device according to a third embodiment of the present invention will be described.

In the third embodiment, timer 24 measures the cumulative light ON time T_{c} for which lamp 16 lights with low power regardless of an operation state such as the normal operation state or the idling mode.

When the cumulative light ON time T_{c} becomes equal to or greater than a predetermined time, controller 25 checks the operations state of display device 1. If the operation state of display device 1 is the normal operation state, controller 25 executes the lamp refresh process. If the operation state of display device 1 is the idling mode, controller 25 causes display device 1 to enter the standby mode. For example, the maximum allowable time of low power lighting of lamp 16 or a predetermined time shorter than the maximum allowable time is used as the predetermined time. The information representing the predetermined time has been stored, for example, in storage unit 23.

According to the second and third embodiments, when lamp driver 15 receives the light ON signal and then supplies low power to lamp 16, lamp driver 15 supplies refresh power to lamp 16 at the allowable interval (specified time). In a state that lamp driver 15 is supplying low power to lamp 16, if controller 25 receives the light OFF signal, after low power is supplied to lamp 16 and the maximum allowable time elapses, controller 25 causes lamp 16 to extinguish.

Thus, after display device 1 causes lamp 16 to light with low power for a time in which the maximum allowable time is subtracted from the time at which lamp 16 lights with low power immediately before display device 1 receives the light OFF signal, display device 1 causes lamp 16 to extinguish. Since display device 1 can prevent lamp 16 from lighting with low power for a time in excess of the maximum allowable time, display device 1 can prevent blackening from occurring inside lamp 16.

According to the second and third embodiments, assuming that the maximum allowable time of low power lighting of lamp 16 is 30 minutes, since the maximum retention time for the idling mode becomes a maximum of 30 minutes, the maximum retention time may become too long. To restrict the length of the maximum retention time, an upper limit value may be set for the maximum retention time for the idling mode. For example, controller 25 may compare the retention time for the idling mode with the upper limit value (for example, 10 minutes) of the maximum retention time. If the retention time becomes equal to or greater than the upper limit value of the maximum retention time, controller 25 causes display device 1 to enter the standby mode.

Thus, if an upper limit value is set for the maximum retention time, the power consumption of lamp 16 that lights with low power can be reduced in display device 1. The upper limit value of the maximum retention time for the idling mode may be set to any time (for example, 10 seconds) by the user of display device 1.

Next, a projection type display device according to a fourth embodiment of the present invention will be described.

Depending on the level of start power supplied to lamp 16 that lights again, blackening may occurs inside lamp 16 due to low power lighting of lamp 16 performed before lamp 16 lights again.

According to the fourth embodiment, a refresh flag that denotes whether or not lamp 16 has lighted with low power is stored as light ON information in storage unit 23. According to the present embodiment, if lamp 16 has lighted with low power, the refresh flag is “1.” If lamp 16 has not lighted with low power, the refresh flag is “0.” Storage unit 23 uses a non-volatile memory that does not lose the contents of the refresh flag even if a power voltage supplied is stopped.

When lamp 16 is caused to light again, controller 25 reads the refresh flag from storage unit 23. If the refresh flag indicates “0,” controller 25 causes lamp driver 15 to supply drive power to lamp 16 without execution of the lamp refresh process.

In contrast, if the refresh flag indicates “1,” controller 25 executes the lamp refresh process. Thus, if controller 25 receives the light ON signal and the refresh flag indicates “1,” lamp driver 15 supplies refresh power to lamp 16 and then supplies drive power thereto.

When lamp driver 15 supplies refresh power to lamp 16, controller 25 updates the refresh flag to “0.” In contrast, when lamp driver 15 supplies low power to lamp 16, controller 25 updates the refresh flag to “1.”

For example, when display device 1 shifts in the normal operation state in which lamp 16 lights with the rated power to the idling mode, lamp 16 lights with low power and controller 25 updates the refresh flag from “0” to “1.” Thus, even if display device 1 is disconnected from the commercial power supply immediately after lamp 16 lights with low power, controller 25 can execute the lamp refresh process for lamp 16 when controller 25 causes lamp 16 to light again.

When display device 1 is disconnected from the commercial power in the normal operation state in which lamp 16 lights with the rated power, the refresh flag indicates “0” because the refresh process is not executed. Thus, when lamp 16 is caused to light again, display device 1 refers to the refresh flag, determines that it is not necessary to execute the lamp refresh process, and thereby does not execute the lamp refresh process.

When display device 1 is disconnected from the commercial power in the normal operation state in which lamp 16 lights with low power, the refresh flag indicates “1.” Thus, when lamp 16 is caused to light again, display device 1 refers to the refresh flag and executes the lamp refresh process.

According to the present embodiment, an example in which immediately after controller 25 causes lamp 16 to light with low power, controller 25 updates the refresh flag to “1” was described. Alternatively, after controller 25 causes lamp 16 to light with low power and a predetermined update period elapses, controller 25 may update the refresh flag to “1.”

For example, similar to the first embodiment, it is assumed that the allowable interval is 20 minutes, the refresh period is 2 minutes, and the maximum allowable time of low power lighting of lamp 16 is 30 minutes. In this case, since the difference between the maximum allowable time and the allowable interval is 10 minutes, even if lamp 16 starts lighting again with low power, if it lights with low power for 10 minutes or less, it is not necessary to execute the lamp refresh process to supply refresh power to lamp 16. For example, even if lamp 16 starts lighting with low power in the state that the lamp refresh process is not executed when lamp 16 is caused to light again, after 20 minutes elapse, the lamp refresh process is executed. Thus, even if lamp 16 lighted with low power for 10 minutes before lamp 16 lights again, the cumulative light ON time for which lamp 16 lights with low power does not exceed the maximum allowable time.

Thus, when the low power light ON time for which lamp 16 lights with low power exceeds an update period of, for example, 5 minutes, controller 25 may update the refresh flag to “1.”

When display device 1 shifts from the normal operation state in which lamp 16 lights with the rated power to the idling mode, after lamp 16 is caused to start lighting with low power and then 5 minutes elapse, controller 25 updates the refresh flag from “0” to “1.” Therefore, in case that display device 1 is disconnected from the commercial power within five minutes after lamp 16 starts lighting with low power, since the refresh flag indicates “0,” the lamp refresh process is not executed when lamp 16 lights again.

On the other hand, in case that display device 1 is disconnected from the commercial power after lamp 16 starts lighting with low power and 5 minutes or more elapse, since the refresh flag indicates “1,” the lamp refresh process is executed when lamp 16 lights again.

Thus, display device 1 can reduce execution of unnecessary lamp refresh process.

When display device 1 shifts the normal operation state in which lamp 16 lights with low power to the idling mode, lamp 16 keeps lighting with low power. After lamp 16 is caused to start lighting with low power in the normal operation state and 5 minutes elapse, controller 25 updates the refresh flag from “0” to “1.”

According to the fourth embodiment, the refresh flag that denotes whether or not lamp 16 has lighted with low power has been stored as light ON information in storage unit 23. When lamp driver 15 receives the light ON signal, if the refresh flag stored in storage unit 23 denotes that lamp 16 has lighted with low power, lamp driver 15 supplies refresh power to lamp 16. In contrast, if the refresh flag denotes that lamp 16 has not lighted with low power, lamp driver 15 supplies drive power to lamp 16.

Therefore, when display device 1 receives the light ON signal which is input by the power ON operation, display device 1 can refer to the refresh flag stored in storage unit 23 and check whether or not low power has been supplied to lamp 16 immediately before lamp 16 has extinguished.

Thus, if low power has not been supplied to lamp 16 immediately before it has extinguished, display device 1 does not supply refresh power to lamp 16. As a result, display device 1 can reduce the execution of unnecessary lamp refresh process.

In each of the foregoing embodiments, the level of low power supplied to lamp 16 in the idling mode may be lower than the level of power supplied to lamp 16 that lights with low power in the normal operation state. However, if the maximum allowable time of low power lighting in the idling mode is different from the maximum allowable time of low power lighting in the normal operation state, their maximum allowable times need to be separately set.

The structures illustrated in the foregoing embodiments are just examples. Thus, it should be appreciated that the present invention is not limited to such structures.

### REFERENCE SIGN LIST

1 Display device

11 Power supply unit

12 Power supply fan

13 Exhaust fan

14 Lamp fan

15 Lamp driver

16 Lamp

17 Shade unit

18 Shade plate driver

19 Input unit

20 Image processer

21 Display element driver

22 Display element

23 Storage unit

24 Timer

25 Controller

What is claimed is:

1. A projection type display device including a lamp employing a halogen cycle; and a display element modulating light emitted from said lamp in response to an image signal, the display device comprising:
a controller generating a control signal that causes first power to be supplied to the lamp and then causes supplying of power to said lamp to be stopped after elapse of a predetermined first time when said controller receives a light OFF signal that causes said lamp to extinguish, the first power being lower than a rated power of said lamp and being lower than power that satisfies said halogen cycle; and
a supply unit supplying power to said lamp in accordance with said control signal.

2. The projection type display device as set forth in claim 1, wherein said first time is shorter than a maximum retention time that is a time for which darkening does not occur inside said lamp that is driven with said first power.

3. The projection type display device as set forth in claim 1, wherein
said supply unit supplies refresh power that is higher than said first power to said lamp for a refresh period at a specified interval when said supply unit receives a light ON signal that causes said lamp to light and thereafter supplies said first power to said lamp,
said controller generates a control signal that causes said lamp to extinguish after elapse of the first time from the supplying of the first power to the lamp when said controller receives said light OFF signal under a condition that the supply unit supplies the first power to said lamp, and
said supply unit supplies power to said lamp in accordance with said control signal.

4. The projection type display device as set forth in claim 3, further comprising:
a storage unit storing light ON information that denotes whether or not said lamp has lighted with said first power,
wherein, when said supply unit receives the light ON signal, said supply unit supplies said refresh power to said lamp if said light ON information denotes that said lamp has lighted with said first power, and said supply unit supplies drive power to said lamp if said light ON information denotes that said lamp has not lighted with said first power.

5. The projection type display device as set forth in claim 1, further comprising:
a fan cooling said lamp,
wherein, when said controller receives a light OFF signal causing the lamp to extinguish, said controller decreases a rotation rate of said fan to a rate smaller than the rotation rate of said fan that occurred immediately before said controller receives said light OFF signal.

6. The projection type display device as set forth in claim 1, wherein said display element projects a black image when said display element receives said light OFF signal.

7. A method of restart processing for a projection type display device including a lamp employing a halogen cycle; and a display element modulating light emitted from said lamp in response to an image signal, the method comprising:
when receiving a light OFF signal that causes said lamp to extinguish, generating a control signal that causes first power to be supplied to the lamp and then causes supplying of power to said lamp to be stopped after elapse of a predetermined first time, the first power being lower than a rated power of said lamp and being lower than power that satisfies said halogen cycle; and
supplying power to said lamp in accordance with said control signal.

8. The method of restart processing as set forth in claim 7, wherein
said supplying power to said lamp includes supplying refresh power that is higher than said first power to said lamp for a refresh period at a specified interval when receiving a light ON signal that causes said lamp to light and thereafter supplying said first power to said lamp,
said generating the control signal includes generating a control signal that causes said lamp to extinguish after elapse of the first time from the supplying of the first power to the lamp when receiving said light OFF signal under a condition that said lamp is supplied with said first power, and
said supplying power to said lamp includes supplying power to said lamp in accordance with said control signal.

9. The method of restart processing as set forth in claim 8, wherein
said projection type display device further includes a storage unit storing light ON information that denotes whether or not said lamp has lighted with said first power, and
said supplying power to said lamp includes, when receiving said light ON signal, supplying said refresh power to said lamp if said light ON signal denotes that said lamp has lighted with said first power, and supplying drive power to said lamp if said light ON information denotes that said lamp has not lighted with said first power.

10. The method as set forth in claim 8, wherein said first time is shorter than a maximum retention time that is a time for which darkening does not occur inside said lamp that is driven with said first power.

11. The projection type display device as set forth in claim 2, wherein
said supply unit supplies refresh power that is higher than said first power to said lamp for a refresh period at a specified interval when said supply unit receives a light ON signal that causes said lamp to light and thereafter supplies said first power to said lamp,
said controller generates a control signal that causes said lamp to extinguish after elapse of the first time from the supplying of the first power to the lamp when said controller receives said light OFF signal under a condition that the supply unit supplies the first power to said lamp, and
said supply unit supplies power to said lamp in accordance with said control signal.

12. The projection type display device as set forth in claim 11, further comprising:
a storage unit storing light ON information that denotes whether or not said lamp has lighted with said first power,
wherein, when said supply unit receives the light ON signal, said supply unit supplies said refresh power to said lamp if said light ON information denotes that said lamp has lighted with said first power, and said supply unit supplies drive power to said lamp if said light ON information denotes that said lamp has not lighted with said first power.

13. The projection type display device as set forth in claim 12, further comprising:
a fan cooling said lamp,
wherein, when said controller receives a light OFF signal causing the lamp to extinguish, said controller decreases a rotation rate of said fan to a rate smaller than the rotation rate of said fan that occurred immediately before said controller receives said light OFF signal.
